(19) United States
(12) Patent Application Publication
(10) Pub. No.: US 2017/0277257 A1
(43) Pub. Date: Sep. 28, 2017

(54) GAZE-BASED SOUND SELECTION

(71) Applicants: Jeffrey Ota, Morgan Hill, CA (US); Kahyun Kim, Portland, OR (US); Alexander Essaian, Santa Clara, CA (US); Emily N. Ivers, Hillsboro, OR (US); Jeremy Miossec-Backer, Hillsboro, OR (US); Paul F. Sorenson, Hillsboro, OR (US)

(72) Inventors: Jeffrey Ota, Morgan Hill, CA (US); Kahyun Kim, Portland, OR (US); Alexander Essaian, Santa Clara, CA (US); Emily N. Ivers, Hillsboro, OR (US); Jeremy Miossec-Backer, Hillsboro, OR (US); Paul F. Sorenson, Hillsboro, OR (US)

(21) Appl. No.: 15/078,652

(22) Filed: Mar. 23, 2016

(51) Int. Cl. G06F 3/01; G06F 17/28; G06T 19/00; H04R 29/00; G02B 27/01; G02B 27/00

(52) U.S. Cl. CPC G06F 3/013; G02B 27/017; G02B 27/0093; G06T 19/006; H04R 29/005; G06F 17/289; G02B 2027/0178

(57) ABSTRACT

Various systems and methods for implementing gaze-based sound selection are described herein. A system for gaze-based sound selection, the system includes a gaze detection circuit to determine a gaze direction of a user, the gaze direction being toward an object; an audio capture mechanism to obtain audio data from the object, the audio capture mechanism selectively configured based on the gaze direction; an audio transformation circuit to transform the audio data to an output data; and a presentation mechanism to present the output data to the user.

### TECHNICAL FIELD

Embodiments described herein generally relate to hearing assistance apparatus and in particular, to gaze-based sound selection.

### BACKGROUND

Augmented reality (AR) viewing may be defined as a live view of a real-world environment whose elements are supplemented (e.g., augmented) by computer-generated sensory input such as sound, video, graphics, or haptic feedback. For example, software applications executed by smartphones may use the smartphone's imaging sensor to capture a real-time event being experienced by a user while overlaying text or graphics on the smartphone display that supplement the real-time event.

A head-mounted display (HMD), also sometimes referred to as a helmet-mounted display, is a device worn on the head or as part of a helmet that is able to project images in front of one or both eyes of a user. An HMD may be used for various applications including augmented reality or virtual reality simulations. HMDs are used in a variety of fields such as military, gaming, sporting, engineering, and training.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is an HMD, according to an embodiment;

FIG. 2 is another HMD, according to embodiment;

FIG. 3 is a schematic diagram illustrating an operating environment, according to an embodiment;

FIG. 4 is a schematic diagram illustrating presenting the output data in an augmented reality display, according to an embodiment;

FIG. 5 is a schematic drawing illustrating an AR subsystem in the form of a head-mounted display, according to an embodiment;

FIG. 6 is a flowchart illustrating control and data flow, according to an embodiment;

FIG. 7 is a block diagram illustrating a system for gaze-based sound selection, according to an embodiment;

FIG. 8 is a flowchart illustrating a method of implementing gaze-based sound selection, according to an embodiment; and

FIG. 9 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Known solutions for real-time translation do not include the ability to select the sound source based on where the user is looking. A user's gaze is closely connected to where the user's attention is directed. Using mechanisms described herein, gaze is used to select the most relevant source for translation or other sound processing.

Systems and methods described herein implement gaze-based sound selection. While gaze may be detected using one or more of multiple methods, many of the embodiments described herein refer to an HMD implementation. HMDs come in a variety of form factors including goggles, visors, glasses, helmets with face shields, and the like. As technology improves, HMDs are becoming more affordable for consumer devices and smaller and lighter to accommodate various applications. Based on where a user is looking, speech or other sounds are amplified, translated, or otherwise processed and presented to the user. The presentation may be provided via the HMD (e.g., in an augmented reality presentation) or with an earpiece, or some other mechanism or combinations of mechanisms.

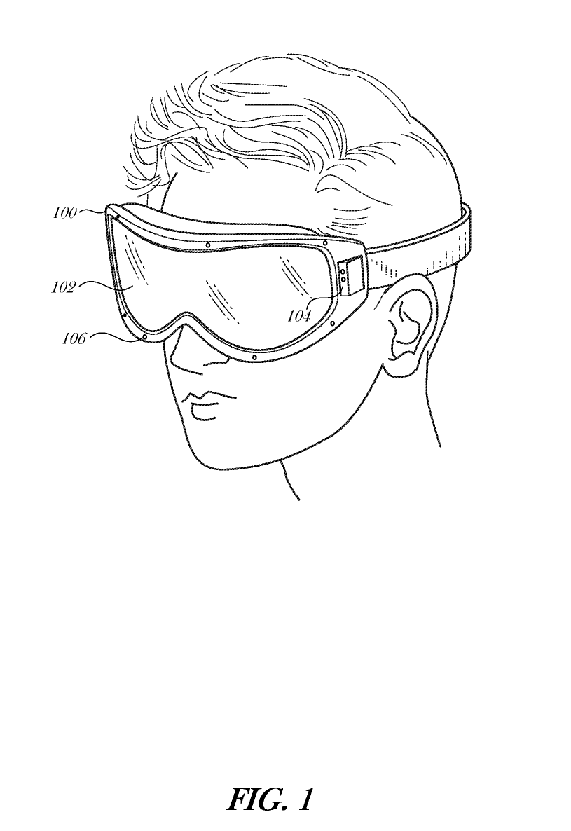

FIG. 1 is an HMD 100, according to an embodiment. The HMD 100 includes a display surface 102, a camera array 104, and processing circuitry (not shown). An image or multiple images may be projected onto the display surface 102, such as by a microdisplay. Alternatively, some or all of the display surface 102 may be an active display (e.g., an organic light-emitting diode (OLED)) display able to produce an image in front of the user. The display also may be provided using retinal projection of various types of light, using a range of mechanisms, including (but not limited to) waveguides, scanning raster, color-separation and other mechanisms.

The camera array 104 may include one or more cameras able to capture visible light, infrared, or the like, and may be used as 2D or 3D cameras (e.g., depth camera). The camera array 104 may be configured to detect a gesture made by the user (wearer).

An inward-facing camera array (not shown) may be used to track eye movement and determine directionality of eye gaze. Gaze detection may be performed using a non-contact, optical method to determine eye motion. Infrared light may be reflected from the user's eye and sensed by an inward-facing video camera or some other optical sensor. The information is then analyzed to extract eye rotation based on the changes in the reflections from the user's retina. Another implementation may use video to track eye movement by analyzing a corneal reflection (e.g., the first Purkinje image) and the center of the pupil. Use of multiple Purkinje reflections may be used as a more sensitive eye tracking method. Other tracking methods may also be used, such as tracking retinal blood vessels, infrared tracking, or near-infrared tracking techniques. A user may calibrate the user's eye positions before actual use.

The HMD 100 includes multiple directional microphones 106 to discriminate from a variety of sound sources that may be coming from a variety of directions. Based on the direction of gaze of the user, one or more directional microphones 106 are used to discriminate a source of sound from the corresponding direction of gaze. The sound is then processed and the user is presented with one or more presentations. For example, when the user is looking at a person who is speaking a foreign language (with respect to the user), the speaker's words may be translated and presented to the user by way of an earpiece (e.g., aurally), visually in the HMD 100 (e.g., scrolling closed caption like presentation or with speech bubbles above the speaker's head in an AR presentation), on an auxiliary device (e.g., on a smartphone held by the user), or combinations of such presentations.

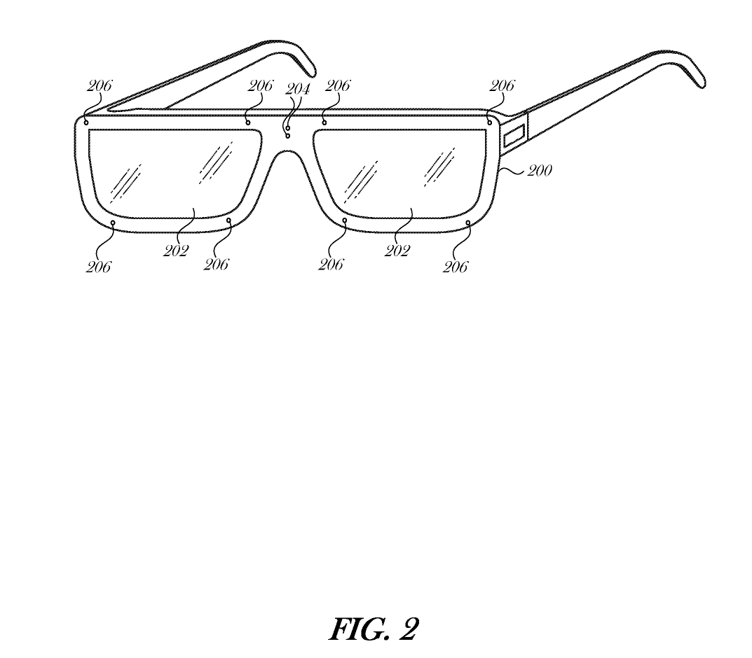

FIG. 2 is another HMD 200, according to embodiment. The HMD 200 in FIG. 2 is in the form of eyeglasses. Similar to the HMD 100 of FIG. 1, HMD 200 includes two display surfaces 202 and a camera array 204. Processing circuitry, inward facing cameras (not shown), and directional microphones 206 may perform the functions described above.

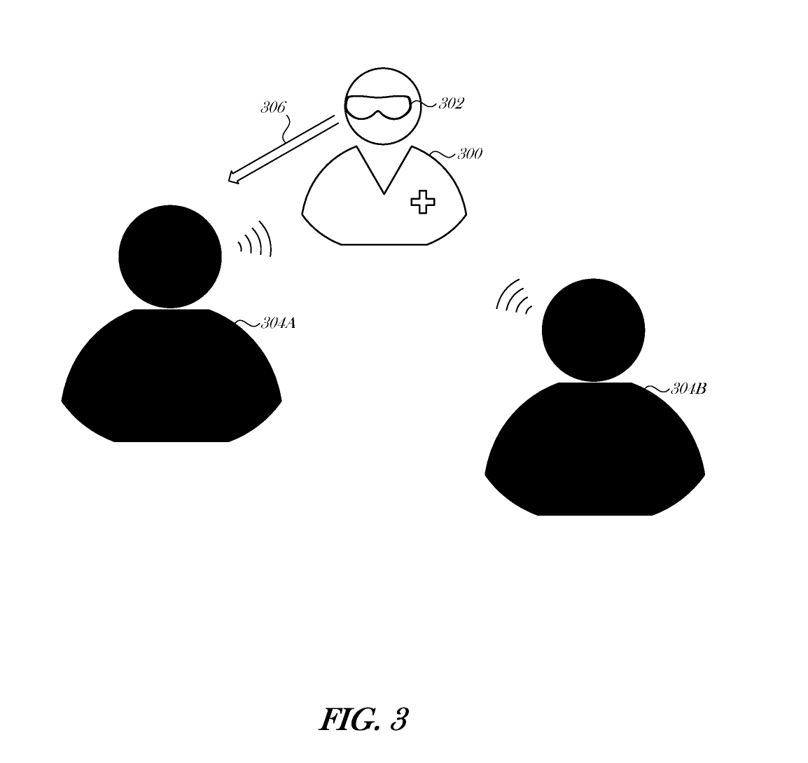

FIG. 3 is a schematic diagram illustrating an operating environment, according to an embodiment. A user 300 wearing an HMD 302 is in a social dialog with multiple parties 304A, 304B. The user's eye gaze direction 306 is determined by the HMD 302, such as with inward facing cameras or other mechanisms. Based on the eye gaze direction 306, a subset of directional microphones is activated. The HMD 302 may incorporate a number of directional microphones that substantially cover the range of the user's vision (e.g., approximately 180 degrees in front of the user 300). The directional microphones may include some that are directed “up” and “down” with respect to the user's point-of-view. As such, the directional microphones may be used to selectively receive sound from a child or an adult, both of whom are talking at the same time and are approximately in the same forward arc of the user (e.g., the child is standing in front of the adult and both are talking, but the child's voice originates from approximately three feet off of the ground, whereas the adult's voice originates from approximately five feet off of the ground). The subset of directional microphones corresponding to the directionality of the eye gaze direction 306 are used to selectively obtain audio from a particular direction (e.g., the eye gaze direction 306). Once the sound is received, additional processes may be used to translate speech, display speech (e.g., for translation or to assist hearing impaired people), amplify sound, or the like, of the sound source corresponding to the eye gaze direction 306 (e.g., party 304A).

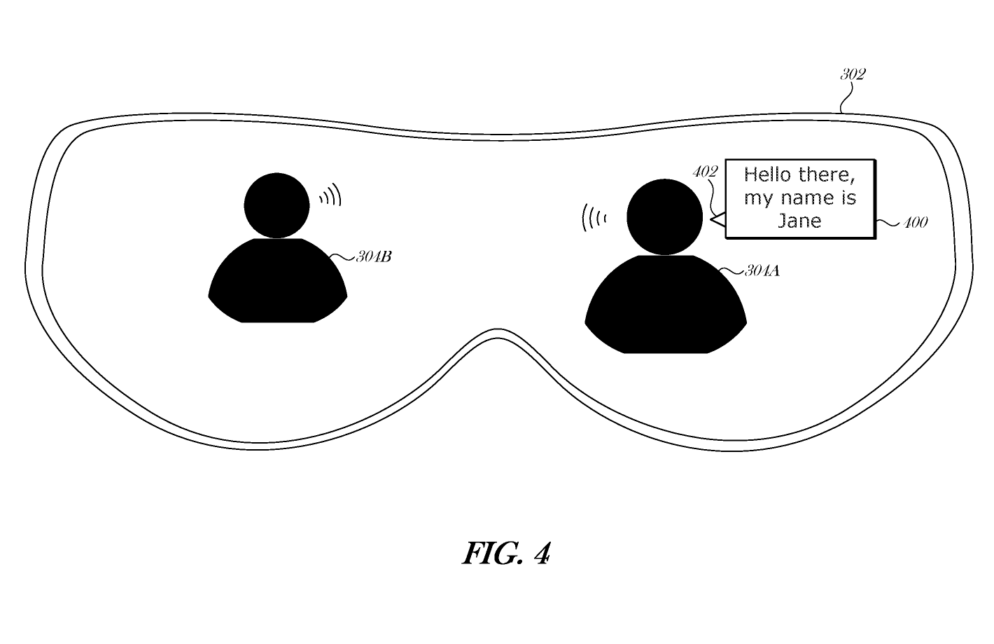

FIG. 4 is a schematic diagram illustrating presenting the output data in an augmented reality display, according to an embodiment. From the user's perspective and continuing the example illustrated in FIG. 3, the user is looking at the person to the user's right. In response, the HMD 302 displays speech-recognized text in a dialog box 400. In the example illustrated in FIG. 4, the dialog box 400 is positioned proximate to the person speaking. Proximate in this context refers to the position of the overlaid graphics that include the text, in the augmented reality presentation. The dialog box 400 is presented close to the real-world object (e.g., person), so that the user is given an intuitive user interface showing which person's speech is being provided. This is further assisted with the triangle portion 402 of the dialog box 400. It is understood that other presentation formats may be used to provide an intuitive interface, such as thought bubbles, a line, scrolling text, or the like.

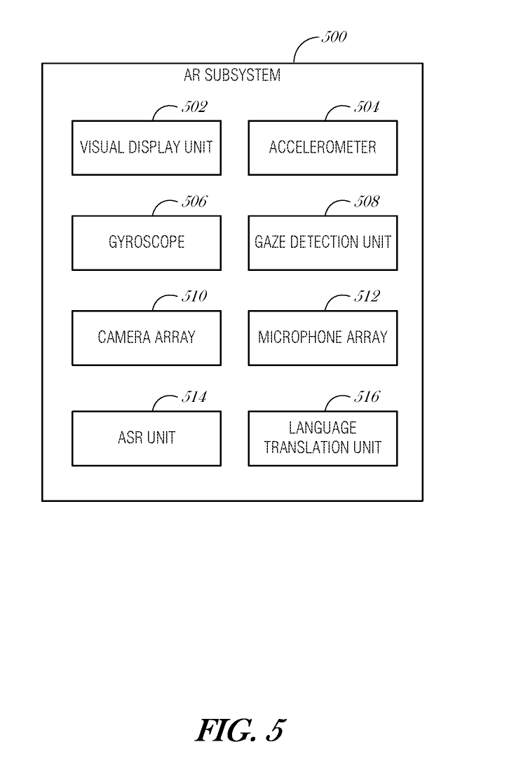

FIG. 5 is a schematic drawing illustrating an AR subsystem 500 in the form of a head-mounted display, according to an embodiment. The AR subsystem 500 includes a visual display unit 502, an accelerometer 504, a gyroscope 506, a gaze detection unit 508, a world-facing camera array 510, and a microphone array 512.

The visual display unit 502 is operable to present a displayed image to the wearer (e.g., user) of the AR subsystem 500. The visual display unit 502 may operate in any manner including projecting images onto a translucent surface between the user's eye(s) and the outer world, the translucent surface may implement mirrors, lenses, prisms, color filters, or other optical apparatus to generate an image. The visual display unit 502 may operate by projecting images directly onto the user's retinas. In general, the visual display unit 502 operates to provide an augmented reality (AR) experience where the user is able to view most of the real world around her with the computer generated image (CGI) (e.g., AR content) being a relatively small portion of the user's field of view. The mixture of the virtual reality images and the real-world experience provides an immersive, mobile, and flexible experience.

Alternatively, in some form factors, the visual display unit 502 may provide an AR experience on a handheld or mobile device's display screen. For example, the visual display unit 502 may be a light-emitting diode (LED) screen, organic LED screen, liquid crystal display (LCD) screen, or the like, incorporated into a tablet computer, smartphone, or other mobile device. When a user holds the mobile device in a certain fashion, a world-facing camera array on the backside of the mobile device may operate to capture the environment, which may be displayed on the screen. Additional information (e.g., AR content) may be presented next to representations of real-world objects. The AR content may be overlaid on top of the real-world object, obscuring the real-world object in the presentation on the visual display unit 502. Alternatively, the presentation of the AR content may be on a sidebar, in a margin, in a popup window, in a separate screen, as scrolling text (e.g., in a subtitle format), or the like.

The AR subsystem 500 includes an inertial tracking system that employs a sensitive inertial measurement unit (IMU). The IMU may include the accelerometer 504 and the gyroscope 506, and optionally includes a magnetometer. The IMU is an electronic device that measures a specific force, angular rate, and sometimes magnetic field around the AR subsystem 500. The IMU may calculate six degrees of freedom allowing the AR subsystem 500 to align AR content to the physical world or to generally determine the position or movement of the user's head.

The gaze detection unit 508 may employ an eye tracker to measure the point of gaze, allowing the AR subsystem 500 to determine where the user is looking. Gaze detection may be performed using a non-contact, optical method to determine eye motion. Infrared light may be reflected from the user's eye and sensed by an inward-facing video camera or some other optical sensor. The information is then analyzed to extract eye rotation based on the changes in the reflections from the user's retina. Another implementation may use video to track eye movement by analyzing a corneal reflection (e.g., the first Purkinje image) and the center of the pupil. Use of multiple Purkinje reflections may be used as a more sensitive eye tracking method. Other tracking methods may also be used, such as tracking retinal blood vessels, infrared tracking, or near-infrared tracking techniques. The gaze detection unit 508 may calibrate the user's eye positions before actual use.

The world-facing camera array 510 may include one or more infrared or visible light cameras, able to focus at long-range or short-range with narrow or large fields of view. The world-facing camera array 510 may be used to capture user gestures for gesture control input, environmental landmarks, people's faces, or other information to be used by the AR subsystem 500.

In operation, while the user is wearing the AR subsystem 500, the user may be interacting with several people, each of whom are talking. When the user looks at one of the talking people, the microphone array 512 is configured to capture audible data emanating from the direction corresponding with the user's gaze. An automatic speech recognition (ASR) unit 514 may be configured to identify speech from the audible data. The ASR unit 504 may interface with a language translation unit 516, which may be used in some cases to translate the received sound data from a first language to a second language.

Once captured and processed, the speech data may be presented in a number of ways, such as by providing an amplified spoken version to the user (e.g., like a hearing aid), presenting text in the visual display unit 502, or combinations of such outputs. The spoken version or the text may be in the same language as the speaker. In this situation, the use of the AR subsystem 500 is to assist the user in hearing or understanding what is being said by the speaker. For example, in a crowded room with many conversations happening simultaneously, hearing what a person is saying may be difficult even for a person with normal hearing capabilities. Alternatively, the spoken version or text presentation may be a translation from the speaker's language to a language that the user understands.

The microphone array 512 may include two or more microphones. The microphones may be directional microphones arranged in a manner such that when a user gazes in a certain direction, a relatively small subset of the microphones in the microphone array 512 are used to pick up the sound from the direction corresponding to the user's gaze. For example, to cover the span of a user's forward gaze (e.g., roughly 180 degrees), eighteen microphones may be used in the microphone array 512, with each microphone covering approximately ten degrees of arc. One, two, or more microphones may be selected from the microphone array 512 that correspond to the direction of the user's gaze.

In addition, more microphones may be included in the microphone array 512 to cover a vertical space, such as for capturing sounds that emanate from below the user's horizon by ten or twenty degrees to above the user's horizon by ten or twenty degrees. Using multiple microphones that point a certain radial direction from the user and then point distinctly at a level, −15°, and +15° from the user's horizon, may be useful to discriminate sounds that may come from a shorter or taller person than the user.

It is understood that the number and orientation of the microphones in the microphone array 512 is flexible and more or fewer microphones may be used depending on the implementation. Additionally, other microphone arrays may be used, such as one that uses paired microphones and associated processing circuitry to use time delay of arrival (TDOA) to determine directionality of source sounds. The processing circuitry may then be used to correlate the user's gaze direction with a sound source in the approximate direction of the gaze, and process sounds that emanate from that direction.

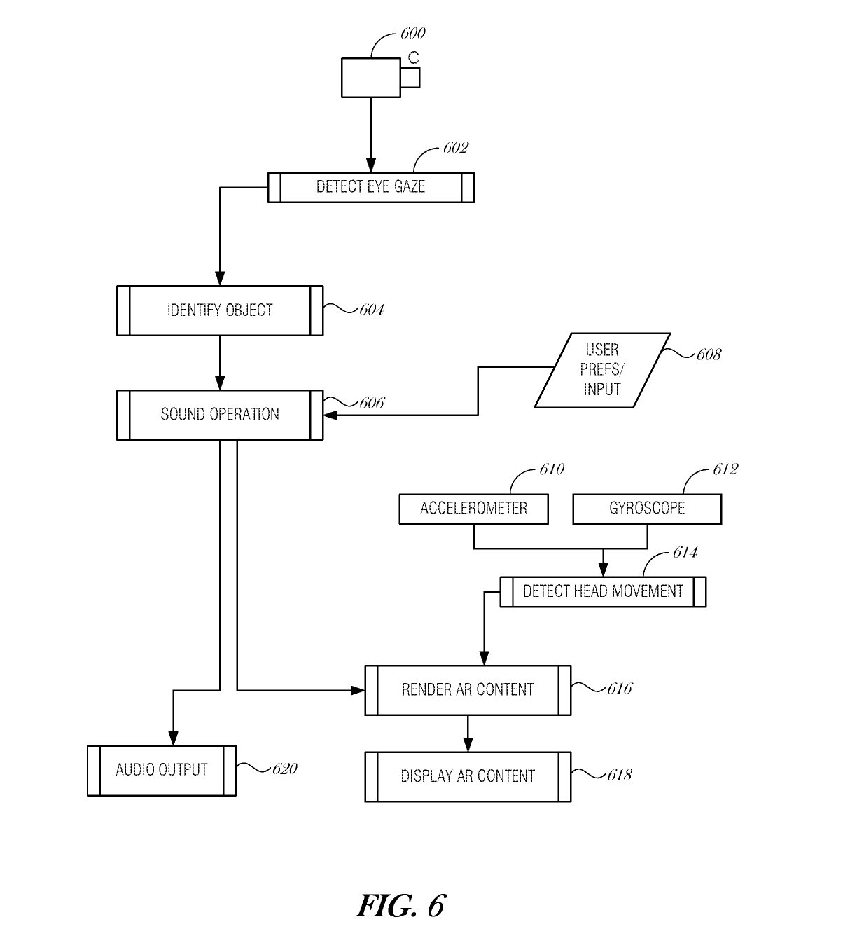

FIG. 6 is a flowchart illustrating control and data flow, according to an embodiment. One or more eye gaze detection cameras 600 are used to detect the direction of the user's eye gaze (operation 602). An object (e.g., a person) is identified based on the gaze direction (operation 604). Based on the object identified by the eye gaze, a sound operation is performed (operation 606). The sound operation performed may be controlled by a user input or by user preferences (item 608). For example, the user may select the operation from a popup dialog box that appears in the AR content or verbalize their selection with a voice command Alternatively, the user may set preferences to always perform translation unless overridden.

An accelerometer 610 and a gyroscope 612 are used to detect head movement (operation 614). AR content is rendered (operation 616) and may be oriented based on the head movement detected at 614 to maintain a consistent visual cohesiveness between AR content and the real world. The AR content is presented to the user at operation 618. The presentation may be in a HMD, on a smartphone, or by other display modalities.

Alternatively, the sound operation 606 may provide an audio output 620. The audio output 620 may be provided to a user via headphones, ear plug, ear buds, hearing aid, cochlear implant, or the like.

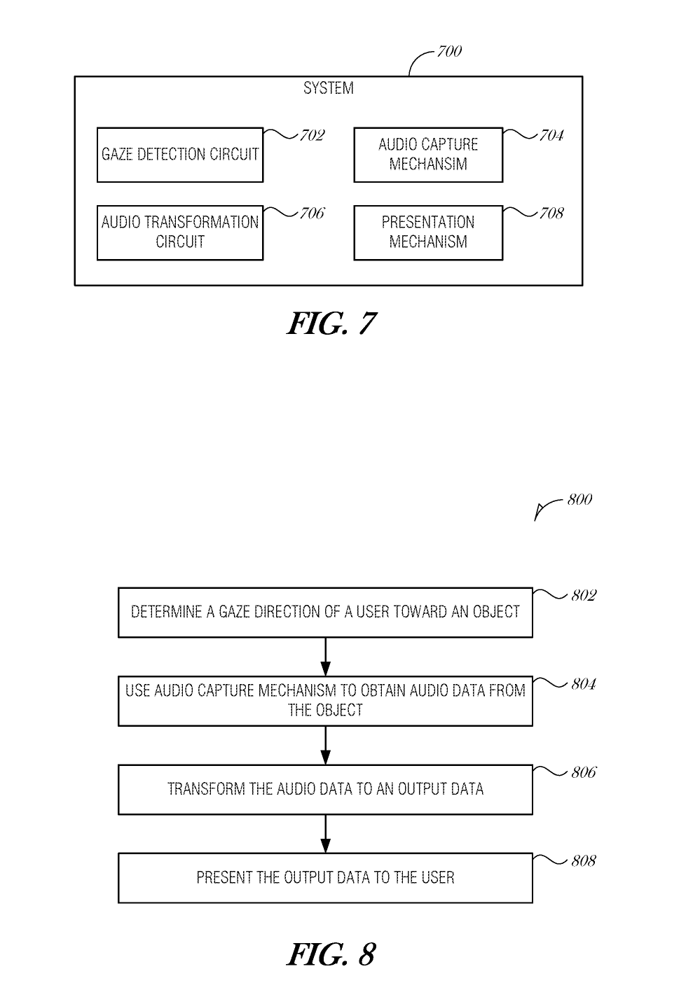

FIG. 7 is a block diagram illustrating a system 700 for gaze-based sound selection, according to an embodiment. The system 700 may include a gaze detection circuit 702, an audio capture mechanism 704, an audio transformation circuit 706, and a presentation mechanism 708.

The gaze detection circuit 702 may be configured to determine a gaze direction of a user, the gaze direction being toward an object. In an embodiment, to determine the gaze of the user, the gaze detection circuit 702 is to detect eye motion using a non-contact optical method. In a further embodiment, the non-contact optical method comprises a retinal infrared light reflection-based technique. In a related embodiment, the non-contact optical method comprises video eye tracking analysis. In a related embodiment, the non-contact optical method comprises a corneal reflection and pupil tracking mechanism.

The audio capture mechanism 704 may be configured to obtain audio data from the object, the audio capture mechanism selectively configured based on the gaze direction. In an embodiment, the audio capture mechanism 704 is to select a subset of directional microphones from an array of directional microphones, the subset of directional microphones oriented in a direction substantially corresponding to the gaze direction of the user, and capture the audio data using the subset of directional microphones.

In an embodiment, the audio capture mechanism 704 is to use a microphone array to determine source direction of a plurality of sound sources, identify a particular sound source of the plurality of sound sources that correlates with the gaze direction of the user, and use the particular sound source to obtain the audio data.

The audio transformation circuit 706 may be configured to transform the audio data to an output data. The presentation mechanism 708 may be configured to present the output data to the user. The presentation mechanism 708 may include an HMD, in an embodiment. Other components may be included in the presentation mechanism 708, such as earphones, speakers, or the like.

In an embodiment, to transform the audio data, the audio transformation circuit 706 is to translate the audio data from a first language to a second language in the output data. In such an embodiment, to present the output data to the user, the presentation mechanism 708 is to produce an audible transcription of the audio data in the second language to the user. In a further embodiment, to produce the audible transcription, the audio transformation circuit 706 is to produce the audible transcription in at least one of: an earphone, an ear bud, or a cochlear implant worn by the user.

In an embodiment, to transform the audio data, the audio transformation circuit 706 is to amplify the audio data to produce the output data. In such an embodiment, to present the output data to the user, the presentation mechanism 708 is to produce the amplified audio data as output data to the user.

In an embodiment, to transform the audio data, the audio transformation circuit 706 is to implement automatic speech recognition of the audio data to produce the output data. In such an embodiment, to present the output data to the user, the presentation mechanism 708 is to display the output data as a readable transcription of the audio data to the user. In a further embodiment, to display the output data, the presentation mechanism 708 is to present the output data in an augmented reality display proximate to a real-world speaker of the audio data. In a further embodiment, to present the output data in the augmented reality display, the presentation mechanism 708 is to present a speech bubble above the head of the real-world speaker.

FIG. 8 is a flowchart illustrating a method 800 of implementing gaze-based sound selection, according to an embodiment. At block 802, a gaze direction of a user is determined, the gaze direction being toward an object. In an embodiment, determining the gaze of the user comprises detecting eye motion using a non-contact optical method. In a further embodiment, the non-contact optical method comprises a retinal infrared light reflection-based technique. In a related embodiment, the non-contact optical method comprises video eye tracking analysis. In a related embodiment, the non-contact optical method comprises a corneal reflection and pupil tracking mechanism.

At block 804, an audio capture mechanism is used to obtain audio data from the object, the audio capture mechanism selectively configured based on the gaze direction. In an embodiment, using the audio capture mechanism comprises selecting a subset of directional microphones from an array of directional microphones, the subset of directional microphones oriented in a direction substantially corresponding to the gaze direction of the user and capturing the audio data using the subset of directional microphones.

In an embodiment, using the audio capture mechanism comprises using a microphone array to determine source direction of a plurality of sound sources, identifying a particular sound source of the plurality of sound sources that correlates with the gaze direction of the user, and using the particular sound source to obtain the audio data.

At block 806, the audio data is transformed to an output data. At block 808, the output data is presented to the user.

In an embodiment, transforming the audio data comprises translating the audio data from a first language to a second language in the output data. In such an embodiment, presenting the output data to the user comprises producing an audible transcription of the audio data in the second language to the user. In a further embodiment, producing the audible transcription comprises producing the audible transcription in at least one of: an earphone, an ear bud, or a cochlear implant worn by the user.

In an embodiment, transforming the audio data comprises amplifying the audio data to produce the output data. In such an embodiment, presenting the output data to the user comprises producing the amplified audio data as output data to the user.

In an embodiment, transforming the audio data comprises implementing automatic speech recognition of the audio data to produce the output data. In such an embodiment, presenting the output data to the user comprises displaying the output data as a readable transcription of the audio data to the user. In a further embodiment, displaying the output data comprises presenting the output data in an augmented reality display proximate to a real-world speaker of the audio data. In a further embodiment, presenting the output data in the augmented reality display comprises presenting a speech bubble above the head of the real-world speaker.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

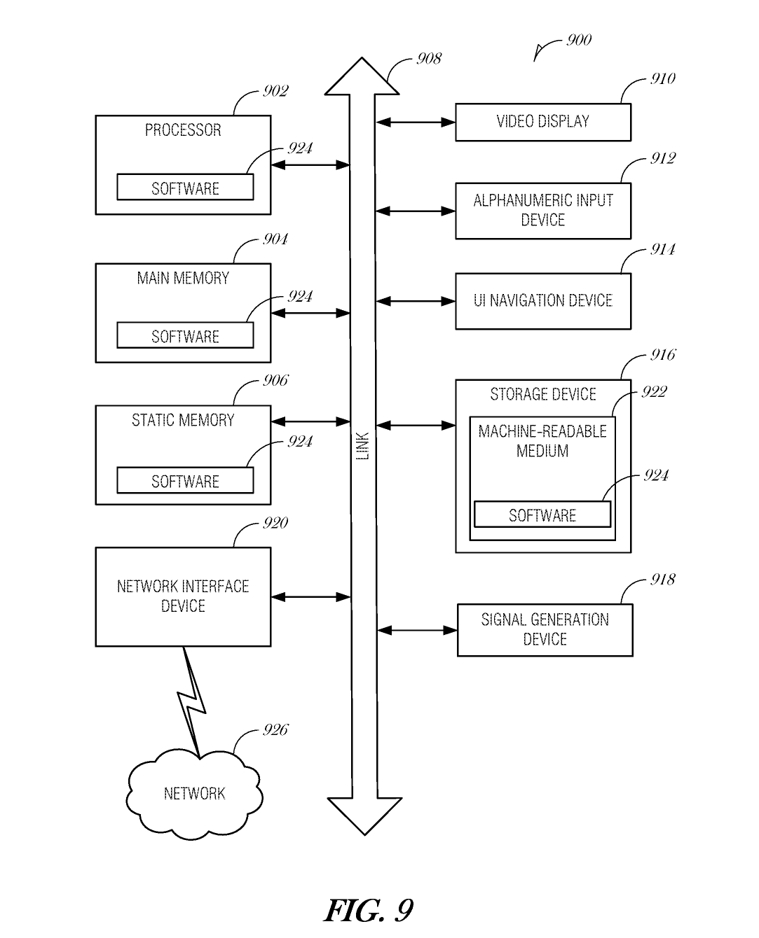

FIG. 9 is a block diagram illustrating a machine in the example form of a computer system 900, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein Similarly, the term “processor-based system” shall be taken to include any set of one or more machines that are controlled by or operated by a processor (e.g., a computer) to individually or jointly execute instructions to perform any one or more of the methodologies discussed herein.

Example computer system 900 includes at least one processor 902 (e.g., a central processing unit (CPU), a graphics processing unit (GPU) or both, processor cores, compute nodes, etc.), a main memory 904 and a static memory 906, which communicate with each other via a link 908 (e.g., bus). The computer system 900 may further include a video display unit 910, an alphanumeric input device 912 (e.g., a keyboard), and a user interface (UI) navigation device 914 (e.g., a mouse). In one embodiment, the video display unit 910, input device 912 and UI navigation device 914 are incorporated into a touch screen display. The computer system 900 may additionally include a storage device 916 (e.g., a drive unit), a signal generation device 918 (e.g., a speaker), a network interface device 920, and one or more sensors (not shown), such as a global positioning system (GPS) sensor, compass, accelerometer, gyrometer, magnetometer, or other sensor.

The storage device 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904, static memory 906, and/or within the processor 902 during execution thereof by the computer system 900, with the main memory 904, static memory 906, and the processor 902 also constituting machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions 924. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is a system for gaze-based sound selection, the system comprising: a gaze detection circuit to determine a gaze direction of a user, the gaze direction being toward an object; an audio capture mechanism to obtain audio data from the object, the audio capture mechanism selectively configured based on the gaze direction; an audio transformation circuit to transform the audio data to an output data; and a presentation mechanism to present the output data to the user.

In Example 2, the subject matter of Example 1 optionally includes, wherein to determine the gaze of the user, the gaze detection circuit is to detect eye motion using a non-contact optical method.

In Example 3, the subject matter of Example 2 optionally includes, wherein the non-contact optical method comprises a retinal infrared light reflection-based technique.

In Example 4, the subject matter of any one or more of Examples 2-3 optionally include, wherein the non-contact optical method comprises video eye tracking analysis.

In Example 5, the subject matter of any one or more of Examples 2-4 optionally include, wherein the non-contact optical method comprises a corneal reflection and pupil tracking mechanism.

In Example 6, the subject matter of any one or more of Examples 1-5 optionally include, wherein the audio capture mechanism is to: select a subset of directional microphones from an array of directional microphones, the subset of directional microphones oriented in a direction substantially corresponding to the gaze direction of the user; and capture the audio data using the subset of directional microphones.

In Example 7, the subject matter of any one or more of Examples 1-6 optionally include, wherein the audio capture mechanism is to: use a microphone array to determine source direction of a plurality of sound sources; identify a particular sound source of the plurality of sound sources that correlates with the gaze direction of the user; and use the particular sound source to obtain the audio data.

In Example 8, the subject matter of any one or more of Examples 1-7 optionally include, wherein to transform the audio data, the audio transformation circuit is to translate the audio data from a first language to a second language in the output data; and wherein to present the output data to the user, the presentation mechanism is to produce an audible transcription of the audio data in the second language to the user.

In Example 9, the subject matter of Example 8 optionally includes, wherein to produce the audible transcription, the audio transformation circuit is to produce the audible transcription in at least one of: an earphone, an ear bud, or a cochlear implant worn by the user.

In Example 10, the subject matter of any one or more of Examples 1-9 optionally include, wherein to transform the audio data, the audio transformation circuit is to amplify the audio data to produce the output data; and wherein presenting the output data to the user comprises produce the amplified audio data as output data to the user.

In Example 11, the subject matter of any one or more of Examples 1-10 optionally include, wherein to transform the audio data, the audio transformation circuit is to implement automatic speech recognition of the audio data to produce the output data; and wherein to present the output data to the user, the presentation mechanism is to display the output data as a readable transcription of the audio data to the user.

In Example 12, the subject matter of Example 11 optionally includes, wherein to display the output data, the presentation mechanism is to present the output data in an augmented reality display proximate to a real-world speaker of the audio data.

In Example 13, the subject matter of Example 12 optionally includes, wherein to present the output data in the augmented reality display, the presentation mechanism is to present a speech bubble above the head of the real-world speaker.

Example 14 is a method of implementing gaze-based sound selection, the method comprising: determining a gaze direction of a user, the gaze direction being toward an object; using an audio capture mechanism to obtain audio data from the object, the audio capture mechanism selectively configured based on the gaze direction; transforming the audio data to an output data; and presenting the output data to the user.

In Example 15, the subject matter of Example 14 optionally includes, wherein determining the gaze of the user comprises detecting eye motion using a non-contact optical method.

In Example 16, the subject matter of Example 15 optionally includes, wherein the non-contact optical method comprises a retinal infrared light reflection-based technique.

In Example 17, the subject matter of any one or more of Examples 15-16 optionally include, wherein the non-contact optical method comprises video eye tracking analysis.

In Example 18, the subject matter of any one or more of Examples 15-17 optionally include, wherein the non-contact optical method comprises a corneal reflection and pupil tracking mechanism.

In Example 19, the subject matter of any one or more of Examples 14-18 optionally include, wherein using the audio capture mechanism comprises: selecting a subset of directional microphones from an array of directional microphones, the subset of directional microphones oriented in a direction substantially corresponding to the gaze direction of the user; and capturing the audio data using the subset of directional microphones.

In Example 20, the subject matter of any one or more of Examples 14-19 optionally include, wherein using the audio capture mechanism comprises: using a microphone array to determine source direction of a plurality of sound sources; identifying a particular sound source of the plurality of sound sources that correlates with the gaze direction of the user; and using the particular sound source to obtain the audio data.

In Example 21, the subject matter of any one or more of Examples 14-20 optionally include, wherein transforming the audio data comprises translating the audio data from a first language to a second language in the output data; and wherein presenting the output data to the user comprises producing an audible transcription of the audio data in the second language to the user.

In Example 22, the subject matter of Example 21 optionally includes, wherein producing the audible transcription comprises producing the audible transcription in at least one of: an earphone, an ear bud, or a cochlear implant worn by the user.

In Example 23, the subject matter of any one or more of Examples 14-22 optionally include, wherein transforming the audio data comprises amplifying the audio data to produce the output data; and wherein presenting the output data to the user comprises producing the amplified audio data as output data to the user.

In Example 24, the subject matter of any one or more of Examples 14-23 optionally include, wherein transforming the audio data comprises implementing automatic speech recognition of the audio data to produce the output data; and wherein presenting the output data to the user comprises displaying the output data as a readable transcription of the audio data to the user.

In Example 25, the subject matter of Example 24 optionally includes, wherein displaying the output data comprises presenting the output data in an augmented reality display proximate to a real-world speaker of the audio data.

In Example 26, the subject matter of Example 25 optionally includes, wherein presenting the output data in the augmented reality display comprises presenting a speech bubble above the head of the real-world speaker.

Example 27 is at least one machine-readable medium including instructions, which when executed by a machine, cause the machine to perform operations of any of the methods of Examples 14-26.

Example 28 is an apparatus comprising means for performing any of the methods of Examples 14-26.

Example 29 is an apparatus for implementing gaze-based sound selection, the apparatus comprising: means for determining a gaze direction of a user, the gaze direction being toward an object; means for using an audio capture mechanism to obtain audio data from the object, the audio capture mechanism selectively configured based on the gaze direction; means for transforming the audio data to an output data; and means for presenting the output data to the user.

In Example 30, the subject matter of Example 29 optionally includes, wherein the means for determining the gaze of the user comprise means for detecting eye motion using a non-contact optical apparatus.

In Example 31, the subject matter of Example 30 optionally includes, wherein the non-contact optical apparatus comprises a retinal infrared light reflection-based technique.

In Example 32, the subject matter of any one or more of Examples 30-31 optionally include, wherein the non-contact optical apparatus comprises video eye tracking analysis.

In Example 33, the subject matter of any one or more of Examples 30-32 optionally include, wherein the non-contact optical apparatus comprises a corneal reflection and pupil tracking mechanism.

In Example 34, the subject matter of any one or more of Examples 29-33 optionally include, wherein the means for using the audio capture mechanism comprise: means for selecting a subset of directional microphones from an array of directional microphones, the subset of directional microphones oriented in a direction substantially corresponding to the gaze direction of the user; and means for capturing the audio data using the subset of directional microphones.

In Example 35, the subject matter of any one or more of Examples 29-34 optionally include, wherein the means for using the audio capture mechanism comprises: means for using a microphone array to determine source direction of a plurality of sound sources; means for identifying a particular sound source of the plurality of sound sources that correlates with the gaze direction of the user; and means for using the particular sound source to obtain the audio data.

In Example 36, the subject matter of any one or more of Examples 29-35 optionally include, wherein the means for transforming the audio data comprise means for translating the audio data from a first language to a second language in the output data; and wherein the means for presenting the output data to the user comprise means for producing an audible transcription of the audio data in the second language to the user.

In Example 37, the subject matter of Example 36 optionally includes, wherein the means for producing the audible transcription comprise means for producing the audible transcription in at least one of: an earphone, an ear bud, or a cochlear implant worn by the user.

In Example 38, the subject matter of any one or more of Examples 29-37 optionally include, wherein the means for transforming the audio data comprise means for amplifying the audio data to produce the output data; and wherein the means for presenting the output data to the user comprises means for producing the amplified audio data as output data to the user.

In Example 39, the subject matter of any one or more of Examples 29-38 optionally include, wherein the means for transforming the audio data comprise means for implementing automatic speech recognition of the audio data to produce the output data; and wherein the means for presenting the output data to the user comprise means for displaying the output data as a readable transcription of the audio data to the user.

In Example 40, the subject matter of Example 39 optionally includes, wherein the means for displaying the output data comprise means for presenting the output data in an augmented reality display proximate to a real-world speaker of the audio data.

In Example 41, the subject matter of Example 40 optionally includes, wherein the means for presenting the output data in the augmented reality display comprise means for presenting a speech bubble above the head of the real-world speaker.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for gaze-based sound selection, the system comprising:
a gaze detection circuit to determine a gaze direction of a user, the gaze direction being toward an object;
an audio capture mechanism to obtain audio data from the object, the audio capture mechanism selectively configured based on the gaze direction;
an audio transformation circuit to transform the audio data to an output data; and
a presentation mechanism to present the output data to the user.

2. The system of claim 1, wherein to determine the gaze of the user, the gaze detection circuit is to detect eye motion using a non-contact optical method.

3. The system of claim 2, wherein the non-contact optical method comprises a retinal infrared light reflection-based technique.

4. The system of claim 2, wherein the non-contact optical method comprises video eye tracking analysis.

5. The system of claim 2, wherein the non-contact optical method comprises a corneal reflection and pupil tracking mechanism.

6. The system of claim 1, wherein the audio capture mechanism is to:
select a subset of directional microphones from an array of directional microphones, the subset of directional microphones oriented in a direction substantially corresponding to the gaze direction of the user; and
capture the audio data using the subset of directional microphones.

7. The system of claim 1, wherein the audio capture mechanism is to:
use a microphone array to determine source direction of a plurality of sound sources;
identify a particular sound source of the plurality of sound sources that correlates with the gaze direction of the user; and
use the particular sound source to obtain the audio data.

8. The system of claim 1, wherein to transform the audio data, the audio transformation circuit is to:
translate the audio data from a first language to a second language in the output data; and
wherein to present the output data to the user, the presentation mechanism is to:
produce an audible transcription of the audio data in the second language to the user.

9. The system of claim 8, wherein to produce the audible transcription, the audio transformation circuit is to produce the audible transcription in at least one of: an earphone, an ear bud, or a cochlear implant worn by the user.

10. The system of claim 1, wherein to transform the audio data, the audio transformation circuit is to:
amplify the audio data to produce the output data; and
wherein presenting the output data to the user comprises:
produce the amplified audio data as output data to the user.

11. The system of claim 1, wherein to transform the audio data, the audio transformation circuit is to:
implement automatic speech recognition of the audio data to produce the output data; and
wherein to present the output data to the user, the presentation mechanism is to:
display the output data as a readable transcription of the audio data to the user.

12. The system of claim 11, wherein to display the output data, the presentation mechanism is to present the output data in an augmented reality display proximate to a real-world speaker of the audio data.

13. The system of claim 12, wherein to present the output data in the augmented reality display, the presentation mechanism is to present a speech bubble above the head of the real-world speaker.

14. A method of implementing gaze-based sound selection, the method comprising:
determining a gaze direction of a user, the gaze direction being toward an object;
using an audio capture mechanism to obtain audio data from the object, the audio capture mechanism selectively configured based on the gaze direction;
transforming the audio data to an output data; and
presenting the output data to the user.

15. The method of claim 14, wherein determining the gaze of the user comprises detecting eye motion using a non-contact optical method.

16. The method of claim 14, wherein using the audio capture mechanism comprises:
selecting a subset of directional microphones from an array of directional microphones, the subset of directional microphones oriented in a direction substantially corresponding to the gaze direction of the user; and
capturing the audio data using the subset of directional microphones.

17. The method of claim 14, wherein using the audio capture mechanism comprises:
using a microphone array to determine source direction of a plurality of sound sources;
identifying a particular sound source of the plurality of sound sources that correlates with the gaze direction of the user; and
using the particular sound source to obtain the audio data.

18. The method of claim 14, wherein transforming the audio data comprises:
translating the audio data from a first language to a second language in the output data; and
wherein presenting the output data to the user comprises:
producing an audible transcription of the audio data in the second language to the user.

19. The method of claim 18, wherein producing the audible transcription comprises producing the audible transcription in at least one of: an earphone, an ear bud, or a cochlear implant worn by the user.

20. The method of claim 14, wherein transforming the audio data comprises:
amplifying the audio data to produce the output data; and
wherein presenting the output data to the user comprises:
producing the amplified audio data as output data to the user.

21. At least one machine-readable medium including instructions, which when executed by a machine, cause the machine to:
determine a gaze direction of a user, the gaze direction being toward an object;
obtain audio data from the object, the audio capture mechanism selectively configured based on the gaze direction;
transform the audio data to an output data; and
present the output data to the user.

22. The at least one machine-readable medium of claim 21, wherein the instructions to transform the audio data include instructions to translate the audio data from a first language to a second language in the output data; and
wherein the instructions to present the output data to the user include instructions to produce an audible transcription of the audio data in the second language to the user.

23. The at least one machine-readable medium of claim 21, wherein the instructions to transform the audio data include instructions to implement automatic speech recognition of the audio data to produce the output data; and
wherein the instructions to present the output data to the user include instructions to display the output data as a readable transcription of the audio data to the user.

24. The at least one machine-readable medium of claim 23, wherein the instructions to display the output data include instructions to present the output data in an augmented reality display proximate to a real-world speaker of the audio data.

25. The at least one machine-readable medium of claim 24, wherein the instructions to present the output data in the augmented reality display include instructions to present a speech bubble above the head of the real-world speaker.
